(19) United States
(12) Patent Application Publication
(10) Pub. No.: US 2010/0150575 A1
(43) Pub. Date: Jun. 17, 2010

(54) Method and Optical Transmitter for Optimizing DC Bias Voltage Input to Optical Modulator with Duo-Binary Modulation

(75) Inventors: Jyung Chan Lee, Daejeon-si (KR); Joon Ki Lee, Daejeon-si (KR); Kwangjoon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute, Daejeon-si (KR)

(21) Appl. No.: 12/550,753

(22) Filed: Aug. 31, 2009

(30) Foreign Application Priority Data
Dec. 16, 2008 (KR) 10-2008-0127963

(51) Int. Cl. H04B 10/04

(52) U.S. Cl. 398/187

(57) ABSTRACT

An optical transmitter is provided which optimizes DC bias voltage input to an optical modulator employing a duo-binary modulation scheme. The optical transmitter including a signal combiner which converts an electrical signal for optical transmission into a high-speed electrical signal, and an optical modulator which receives and modulates the high-speed electrical signal from the signal combiner further includes a frequency divider to divide frequency of a sinusoidal watchdog clock signal from the signal combiner and to output the divided signal to be added to direct current (DC) bias voltage input to the optical modulator; and a bias voltage modifier to adjust the DC bias voltage by analyzing the modulated electrical signal from the optical modulator. Accordingly, it is possible to conveniently optimize the DC bias voltage with a simple design.

### CROSS-REFERENCE TO RELATED APPLICATION

This application claims the benefit under 35 U.S.C. §119(a) of Korean Patent Application No. 10-2008-0127963, filed on Dec. 16, 2008, the disclosure of which is incorporated by reference in its entirety for all purposes.

### BACKGROUND

1. Field

The following description relates to an optical transmission technology and, more particularly, to a technology for stabilizing direct current (DC) bias voltage of an external modulator employing a duo-binary modulation scheme.

2. Description of the Related Art

An optical transmitter for high-speed long-haul transmission has a modulator which employs direct modulation for controlling current applied to a light source and external modulation where an external modulator is used. The direct modulation is employed for low transmission speed, while the external modulation is employed for high transmission speed since the direction modulation creates a chirp at a high transmission speed.

An existing external modulation scheme uses non-return-to-zero (NRZ). During data modulation using the existing NRZ, however, an abrupt increase in data traffic and a high-speed data transmission request cause significant interference and distortion between channels, thereby imposing a restriction in transmission capacity expansion. Furthermore, a direct current (DC) frequency component and a spread high-frequency component of a conventional binary NRZ signal cause non-linearity and dispersion of the signal when propagated through an optical fiber, thereby imposing a restriction in transmission distance at high-speed transmission.

A duo-binary technology is increasingly popular as an optical transmission technology to overcome the restriction in transmission distance due to chromatic dispersion. The duo-binary transmission has an advantage in that transmission spectrum is reduced compared to typical binary transmission. For a limited dispersion system, a transmission distance is inversely proportional to the second power of a transmission spectrum bandwidth. Hence, if the transmission spectrum bandwidth is reduced by half, the transmission distance increases by four times. Moreover, since carrier frequency is suppressed within the duo-binary transmission spectrum, it is possible to relieve a restriction in optical output power due to Brillouin scattering within optical fiber.

However, an external modulator employing the duo-binary modulation scheme, such as a Mach-Zehner optical modulator, experiences DC bias drift of a transfer curve according to a variation in surrounding temperature. This occurs in any modulation scheme using a Mach-Zehnder interferometer type optical modulator. This causes a deformed eye pattern of a duo-binary optical signal, leading to a transmission error.

### SUMMARY

The following description relates to an optical modulator employing duo-binary modulation which outputs a stable signal regardless of a change in temperature by optimizing direct current (DC) bias voltage.

In one general aspect, an optical transmitter including a signal combiner which converts an electrical signal for optical transmission into a high-speed electrical signal, and an optical modulator which receives and modulates the high-speed electrical signal from the signal combiner further includes a frequency divider to divide frequency of a sinusoidal watchdog clock signal from the signal combiner and to output the divided signal to be added to direct current (DC) bias voltage input to the optical modulator; and a bias voltage modifier to adjust the DC bias voltage by analyzing the modulated electrical signal from the optical modulator.

The bias voltage modifier may include a controller which controls output frequency of the frequency divider by considering divider ratio information which is used by the signal combiner to divide frequency of the high-speed electrical signal and generate the sinusoidal watchdog clock signal.

The bias voltage modifier may include a detector which includes a phase detector to detect phase of the signal output from the optical modulator and phase of the signal output from the frequency divider; a controller which outputs a control signal to control the DC bias voltage according to data output from the detector; and a DC bias adjustor which adjusts the DC bias voltage according to the control signal output from the controller.

The detector may further include a voltage detector to detect high and low peak voltages of the signal output from the optical modulator.

The bias voltage modifier may include a detector which detects high and low peak voltages of the signal output from the optical modulator; a controller which outputs a control signal to control the DC bias voltage according to data output from the detector; and a DC bias adjustor which adjusts the DC bias voltage according to the control signal output from the controller.

In another general aspect, a method of optimizing direct current (DC) bias voltage input to an optical modulator which is performed in a processor of an optical transmitter including a signal combiner which converts an electrical signal for optical transmission into a high-speed electrical signal and the optical modulator which receives the high-speed electrical signal from the signal combiner and modulates the high-speed electrical signal in a duo-binary modulation scheme includes dividing frequency of a sinusoidal watchdog clock signal which is output from the signal combiner, added to DC bias voltage, and input to the optical modulator; determining if a difference between phase of a signal, which is optically modulated, electrically converted and output, and is filtered to the same frequency band as that of the divided frequency of the watchdog clock signal, and phase of the watchdog clock signal, which is frequency divided, satisfies a reference phase condition; and adjusting the DC bias voltage unless the difference satisfies the reference phase condition.

In another general aspect, a method of optimizing direct current (DC) bias voltage input to an optical modulator which is performed in a processor of an optical transmitter including a signal combiner which converts an electrical signal for optical transmission into a high-speed electrical signal and the optical modulator which receives the high-speed electrical signal from the signal combiner and modulates the high-speed electrical signal in a duo-binary modulation scheme includes dividing frequency of a sinusoidal watchdog clock signal which is output from the signal combiner, added to DC bias voltage, and input to the optical modulator; determining if high and low peak voltages of a signal, which is optically modulated, electrically converted and output, and is filtered to the same frequency band as that of the divided frequency of the watchdog clock signal, satisfy a reference voltage condition; and adjusting the DC bias voltage unless the high and low peak voltages satisfy the reference voltage condition.

However, other features and aspects will be apparent from the following description, the drawings, and the claims.

### BRIEF DESCRIPTION OF THE DRAWINGS

FIG. 1 shows an example of an eye pattern of an optical signal at an optimum DC bias voltage and a non-optimum DC bias voltage in a duo-binary modulation scheme.

FIG. 2 is a block diagram of an optical transmitter according to an exemplary embodiment of the present invention.

FIG. 3 illustrates signals from the optical transmitter in FIG. 2.

FIG. 4 is a graph illustrating a change in bit error ratio (BER) of an optical signal (10 Gb/s duo-binary optical signal out), which is output from the optical modulator 220, according to a variation in DC bias voltage.

FIG. 5 is a flow chart of reference information setting according to an exemplary embodiment of the present invention.

FIG. 6 is a flow chart of optimization of DC bias voltage which is input to the optical modulator employing duo-binary modulation according to an exemplary embodiment of the present invention.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

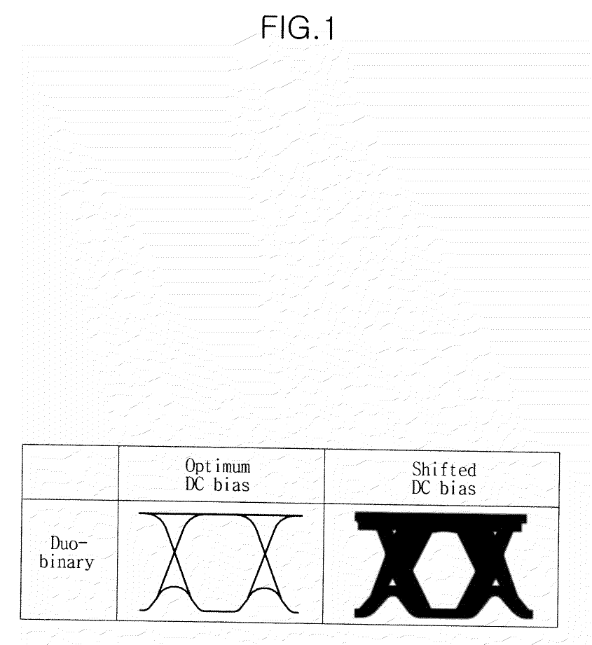

FIG. 1 shows an example of an eye pattern of an optical signal at an optimum DC bias voltage and a non-optimum DC bias voltage. The eye pattern has changed, leading to a degraded performance in a transmission system.

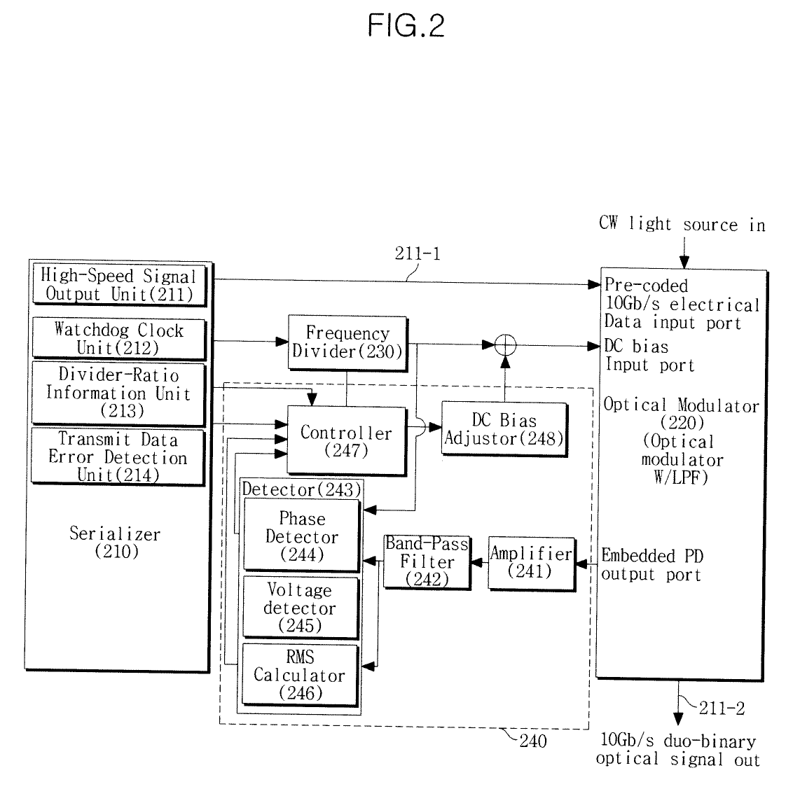

FIG. 2 is a block diagram of an optical transmitter according to an exemplary embodiment of the present invention.

The optical transmitter includes a serializer 210, an optical modulator 220, and a bias voltage modifier 240.

The serializer 210 includes a high-speed signal output unit 211, a watchdog clock unit 212, a divider-ratio information unit 213, and a transmit data error monitor unit 214. The high-speed signal output unit 211 converts a low-speed input signal into a high-speed electrical signal (pre-coded 10 Gb/s electrical signal). The watchdog clock unit 212 outputs a watchdog clock signal in a sine wave of a divider ratio of 1/16 or 1/64 of a high-speed signal. The divide-ratio information unit 213 provides a controller 247 with divider-ratio information used in the watchdog clock. The transmit data error detection unit 214 detects an error on a signal 211-1 input to the optical modulator 220. The high-speed signal output function, watchdog clock function, and transmit data error detection function are well known in the art.

The optical modulator 220 is an external modulator employing duo-binary data modulation and may be a Mach-Zehnder optical modulator. As shown in FIG. 2, the optical modulator 220 includes a continuous wave (CW) light source input port, a pre-coded 10 Gb/s electrical data input port, a 10 G/b duo-binary optical signal output port, a DC bias input port, and an embedded photo diode (PD) output port. At the embedded PD output port, an electrical signal into which a part of an optical signal divided in the optical modulator 220 is converted is output.

A frequency divider 230 receives a watchdog clock signal in a sine wave of a divider ratio of 1/16 or 1/64 of a high-speed signal from the watchdog clock unit 212, divides frequency of the watchdog clock signal, and outputs a sinusoidal signal with a frequency of several kHz.

The bias voltage modifier 240 analyzes an electrical signal from the embedded PD output port of the optical modulator 220 and optimizes DC bias voltage input to the DC bias input port of the optical modulator 220 based on the analysis result.

As shown in FIG. 2, the bias voltage modifier 240 includes an amplifier 241, a band-pass filter 270, a detector 243, a controller 247, and a DC bias adjustor 248. The amplifier 241 amplifies an electrical signal from the embedded PD output port of the optical modulator 220. The band-pass filter 242 filters the amplified signal into the same frequency band as that of the frequency divider 230. The detector 243 detects a specific component from the output signal of the band-pass filter 242.

In one embodiment, the detector 243 may include a phase detector and/or a voltage detector 245. The phase detector 244 receives sinusoidal signals from the band-pass filter 242 and the frequency divider 230 and detects phase information, e.g., phase difference, between the two sinusoidal signals. The voltage detector 245 receives a sinusoidal signal from the band-pass filter 242 and detects peak-to-peak voltage information, e.g., a difference between a high peak voltage and a low peak voltage, of the signal. If the detector 243 includes the voltage detector 245, the detector 243 may further include a RMS calculator 246. The RMS calculator 246 calculates a root-mean-square of the difference between the high and low peak voltages.

The controller 247 receives a signal from the detector 243 and outputs a control signal to the DC bias adjustor 248 to control DC bias voltage input to the optical modulator 220. In one embodiment, the controller 247 has reference phase information, reference peak-to-peak voltage information or reference RMS information therein. The controller 247 further has information about a DC bias adjusting value to be adjusted one time. The reference information is for optimizing the DC bias voltage input to the optical modulator 220. The controller 247 compares reference phase information with current phase information detected by the phase detector 244, and maintains the current DC bias voltage if they match. Unless they match, the controller 247 outputs a control signal to the DC bias adjustor 248 to increase or decrease the DC bias voltage by an adjusting value previously stored in its memory.

Moreover, the controller 247 compares a reference peak-to-peak voltage with a current peak-to-peak voltage detected by the voltage detector 245 and, if they match, maintains the current DC bias voltage; otherwise, it outputs a control signal to the DC bias adjustor 248 to increase or decrease the DC bias voltage by an adjusting value. Alternatively, the controller 247 compares a reference voltage RMS value with a current voltage RMS value detected by the voltage detector 245 and, if they match, maintains the current DC bias voltage; otherwise, it outputs a control signal to the DC bias adjustor 248 to increase or decrease the DC bias voltage by an adjusting value. The DC bias adjustor 248 increases or decreases the DC bias voltage according to the control signal from the controller 247.

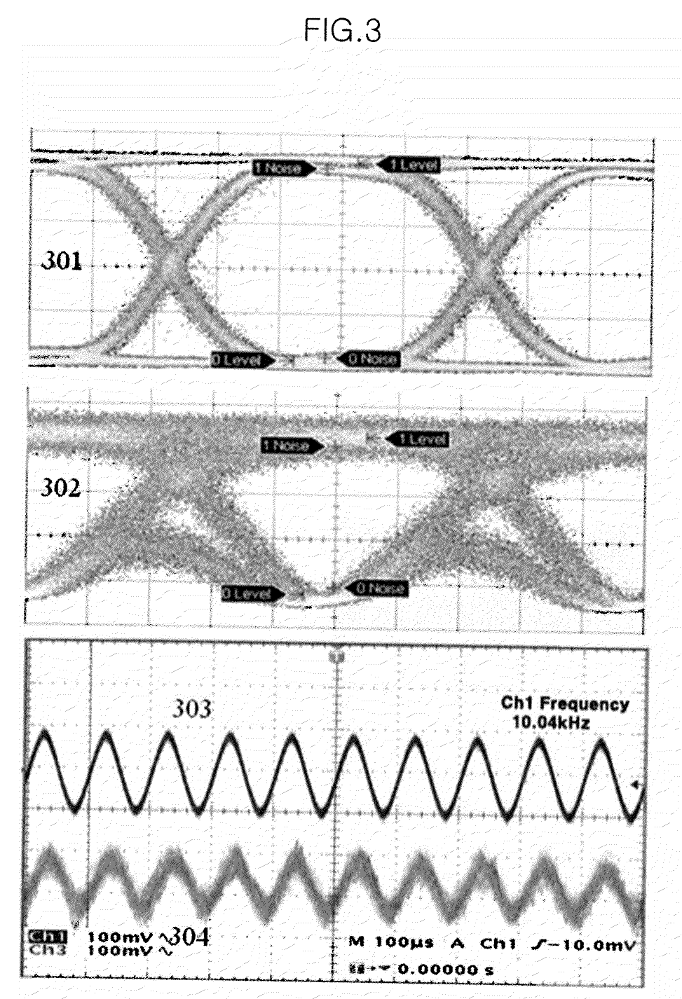

FIG. 3 illustrates signals from the optical transmitter: an eye 301 of data 211-1 which is input to the optical modulator 220; an eye 302 of a duo-binary modulated optical signal 211-2 which is output from the optical modulator 220; a signal 303 which is a combined signal from the DC bias adjustor 248 and the frequency divider 230 and is input to the optical modulator 220; a signal 304 which has passed through the amplifier 241 and the band-pass filter 242.

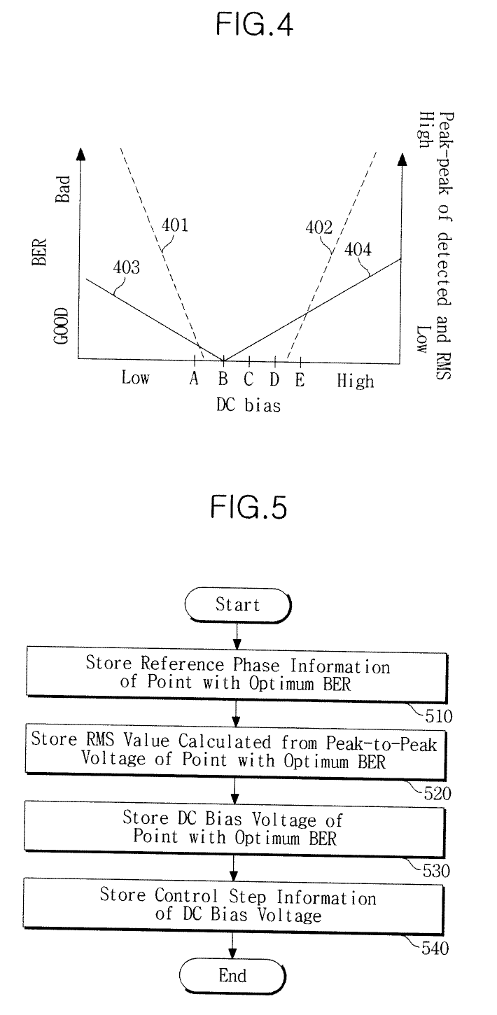

FIG. 4 is a graph illustrating a change in bit error ratio (BER) of an optical signal (10 Gb/s duo-binary optical signal out), which is output from the optical modulator 220, according to a variation in DC bias voltage.

Phase information between the signals 303 and 304, a difference between high and low peaks of the signal 304 and its RMS value, and a change in bit error ratio of the optical signal 402 according to a variation in DC bias voltage among combined alternate current (AC), which is output from the frequency divider 230, and DC bias voltage will now be described.

The solid lines 403 and 404 indicate the difference between the high and low peaks and its RMS value according to a variation in DC bias voltage. The dotted lines 401 and 402 indicate a change in BER of the optical signal 402 according to the variation in DC bias voltage. As can be seen from FIG. 4, when the DC bias voltage is changed from point A to point E, the difference between the high and low peaks and its RMS value are lowest at point B. In addition, it can be seen that the solid lines 403 and 404 exhibit different phases.

Similarly, when the DC bias voltage is changed from A to E, it can be seen from the dotted lines 401 and 402 that the BER is poor at A and E and becomes increasingly good towards point C. In other words, at the points A and E, an error occurs; at the points B and D, no error occurs but an error may abruptly occur when the DC bias voltage changes; at the point C, no error occurs in any case and thus an optimum DC bias voltage is obtained.

As a result, it can be seen from the lines 401, 402, 403 and 404 that the points B and C indicate an optimum DC bias voltage. There is a difference between the two points.

FIG. 5 is a flow chart of reference information setting according to an exemplary embodiment of the present invention.

Before optimizing the DC bias voltage, at S510, S520 and S540, the controller 247 stores the phase information and RMS value at the point C and control step information of the DC bias voltage in its internal memory. At S530, the controller 247 stores initial DC bias voltage information in the internal memory.

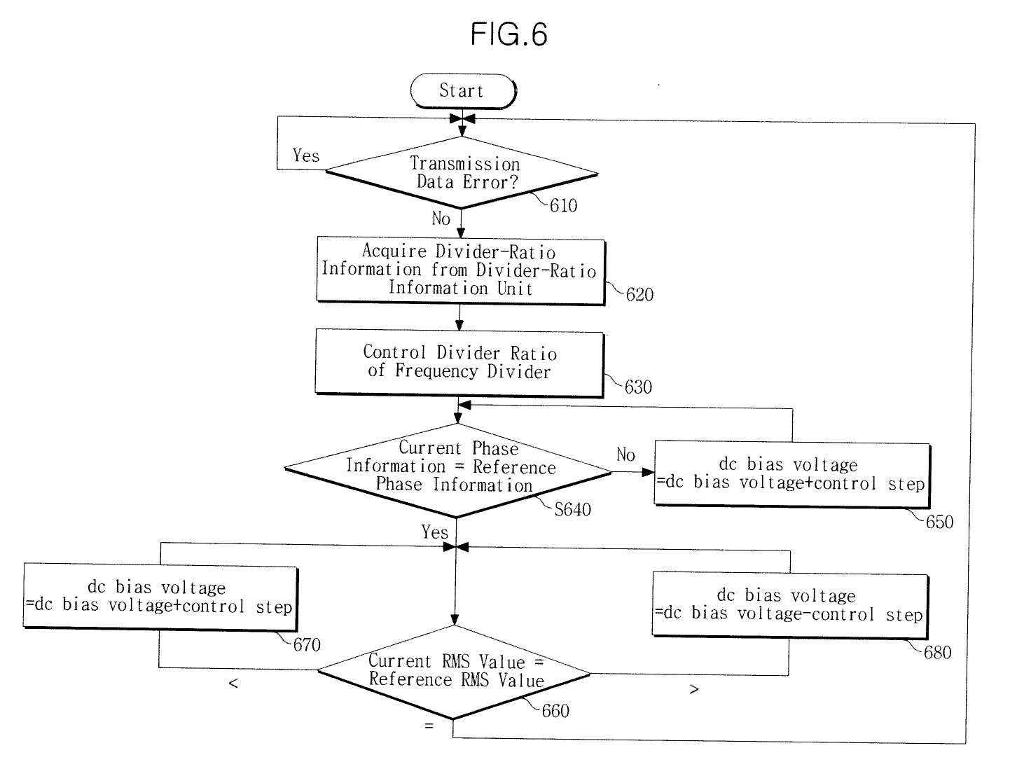

FIG. 6 is a flow chart of optimization of DC bias voltage which is input to the optical modulator employing duo-binary modulation according to an exemplary embodiment of the present invention.

The controller 247 controls the DC bias adjustor 248 to input initial DC bias voltage stored in the internal memory to the optical modulator 220. At S610, the controller 247 determines from information about transmission data locking from the transmit data error detection unit 214 in the serializer 210 if there is an error on transmit data. If no error occurs, at S620, the controller 247 reads divider-ratio information from the divider-ratio information unit 213 in the serializer 210. At S630, with the divider-ratio information, the controller 247 controls the frequency divider 230 to output a sinusoidal signal with a frequency of several kHz.

At S640, the controller 247 determines if current phase information detected by the phase detector 244 matches reference phase information previously stored in the internal memory. Unless they match, at S650, the controller 247 outputs a control signal to the DC bias adjustor 248 to add a control step stored in the memory to the current DC bias voltage. The DC bias adjustor 248 increases the current DC bias voltage by the control step. S640 and S650 are repeatedly performed until they match.

If they match, at S660, the controller 247 determines if a current RMS value calculated by the RMS calculator 246 matches a reference RMS value stored in the internal memory. If the current RMS value is smaller than the reference RMS value, at S670, the controller 247 outputs a control signal to the DC bias adjustor 248 to add a control step to the current DC bias voltage. If the current RMS value is greater than the reference RMS value, at S680, the controller 247 outputs a control signal to the DC bias adjustor 248 to subtract a control step from the current DC bias voltage. S660, S670 and S680 are repeatedly performed until they match.

At S660, the controller 247 may compare a voltage difference between the high and low Is peaks rather than the RMS value. In this case, the controller 247 compares a voltage difference between the high and low peaks, which is detected by the voltage detector 245, with a reference voltage difference previously stored in the memory to control the DC bias adjustor 248.

Although the controller 247 detects both the phase and the voltage in FIG. 6, the controller 247 may be configured to detect only any one of them.

As apparent from the above description, since the DC bias voltage input to the optical modulator employing the duo-binary modulation scheme is quickly adjusted and optimized, it is possible to stabilize the output power and transmission signal of the optical modulator.

In particular, according to an exemplary embodiment of the present invention, the controller monitors information about transmission data locking from the serializer to determine if an error occurs on the signal input to the optical modulator, and optimizes the DC bias voltage.

To optimize the DC bias voltage, the sinusoidal watchdog clock signal with a divider ratio of 1/16 or 1/64 of a high-speed signal is added to the DC bias voltage. Furthermore, the frequency divider outputs a sinusoidal signal with a frequency of several kHz and makes use of the clock signal from the optical transmitter to optimize the DC bias voltage. Accordingly, it is possible to simplify a peripheral circuit of the optical transmitter.

In addition, the phase change information and peak-to-peak voltage information of sinusoidal signals which are input to and output from the optical modulator are used to optimize the DC bias voltage. Conventionally, around points where there is or is not a BER error at points where the phase of the detected sinusoidal signal is changed, it is not possible to optimize the DC bias voltage only with the phase information. The present invention addresses the problem. Furthermore, it should be noted that a point where the amplitude of a detected sinusoidal signal is smallest in a range where there is no BER error is not located in the very middle of the range where there is no BER error.

Accordingly, it is possible to track and control a more optimum point in an optimum range of the DC bias voltage. Furthermore, it is possible to conveniently control the DC bias voltage with a simple design.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical transmitter comprising a signal combiner which converts an electrical signal for optical transmission into a high-speed electrical signal, and an optical modulator which s receives and modulates the high-speed electrical signal from the signal combiner, the optical transmitter further comprising:
a frequency divider to divide frequency of a sinusoidal watchdog clock signal from the signal combiner and to output the divided signal to be added to direct current (DC) bias voltage input to the optical modulator; and
a bias voltage modifier to adjust the DC bias voltage by analyzing the modulated electrical signal from the optical modulator.

2. The optical transmitter of claim 1, wherein the signal combiner divides frequency of the high-speed electrical signal and outputs the sinusoidal watchdog clock signal.

3. The optical transmitter of claim 2, wherein the bias voltage modifier comprises a controller which controls output frequency of the frequency divider by considering divider ratio information which is used by the signal combiner to divide frequency of the high-speed electrical signal and generate the sinusoidal watchdog clock signal.

4. The optical transmitter of claim 1, wherein the bias voltage modifier comprises:
a detector which comprises a phase detector to detect phase of the signal output from the optical modulator and phase of the signal output from the frequency divider;
a controller which outputs a control signal to control the DC bias voltage according to data output from the detector; and
a DC bias adjustor which adjusts the DC bias voltage according to the control signal output from the controller.

5. The optical transmitter of claim 4, wherein the bias voltage modifier further comprises:
an amplifier to amplify the signal output from the optical modulator; and
a band-pass filter to filter the amplified signal into the same frequency band as that of the output signal of the frequency divider and to output the filtered signal to the detector.

6. The optical transmitter of claim 4, wherein the detector further comprises a voltage detector to detect high and low peak voltages of the signal output from the optical modulator.

7. The optical transmitter of claim 6, wherein the detector further comprises a root-mean-square (RMS) of a difference between the detected high and low peak voltages.

8. The optical transmitter of claim 6, wherein the bias voltage modifier further comprises:
an amplifier to amplify the signal output from the optical modulator; and
a band-pass filter to filter the amplified signal into the same frequency band as that of the output signal of the frequency divider and to output the filtered signal to the detector.

9. The optical transmitter of claim 1, wherein the bias voltage modifier comprises:
a detector which detects high and low peak voltages of the signal output from the optical modulator;
a controller which outputs a control signal to control the DC bias voltage according to data output from the detector; and
a DC bias adjustor which adjusts the DC bias voltage according to the control signal output from the controller.

10. The optical transmitter of claim 9, wherein the detector further comprises a root-mean-square (RMS) of a difference between the detected high and low peak voltages.

11. The optical transmitter of claim 9, wherein the bias voltage modifier further comprises:
an amplifier to amplify the signal output from the optical modulator; and
a band-pass filter to filter the amplified signal into the same frequency band as that of the output signal of the frequency divider and to output the filtered signal to the detector.

12. The optical transmitter of claim 1, wherein the optical modulator is a Mach-Zehnder optical modulator.

13. A method of optimizing direct current (DC) bias voltage input to an optical modulator which is performed in a processor of an optical transmitter including a signal combiner which converts an electrical signal for optical transmission into a high-speed electrical signal and the optical modulator which receives the high-speed electrical signal from the signal combiner and modulates the high-speed electrical signal in a duo-binary modulation scheme, the method comprising:
dividing frequency of a sinusoidal watchdog clock signal which is output from the signal combiner, added to DC bias voltage, and input to the optical modulator;
determining if a difference between phase of a signal, which is optically modulated, electrically converted and output, and is filtered to the same frequency band as that of the divided frequency of the watchdog clock signal, and phase of the watchdog clock signal, which is frequency divided, satisfies a reference phase condition; and
adjusting the DC bias voltage unless the difference satisfies the reference phase condition.

14. The method of claim 13, further comprising:
determining if high and low peak voltages of a signal, which is optically modulated, electrically converted and output, and is filtered to the same frequency band as that of the divided frequency of the watchdog clock signal, satisfy a reference voltage condition; and
adjusting the DC bias voltage unless the high and low peak voltages satisfy the reference voltage condition.

15. The method of claim 13, further comprising:
determining if a root-mean-square (RMS) of high and low peak voltages of a signal, which is optically modulated, electrically converted and output, and is filtered to the same frequency band as that of the divided frequency of the watchdog clock signal, satisfies a reference RMS value; and
adjusting the DC bias voltage unless the RMS of the high and low peak voltages satisfies the reference RMS value.

16. The method of claim 13, wherein if there is an error on the signal input to the optical modulator, adjusting the DC bias voltage is not performed.

17. The method of claim 16, wherein it is determined from information about transmission data locking if there is an error on the signal input to the optical modulator.

18. A method of optimizing direct current (DC) bias voltage input to an optical modulator which is performed in a processor of an optical transmitter including a signal combiner which converts an electrical signal for optical transmission into a high-speed electrical signal and the optical modulator which receives the high-speed electrical signal from the signal combiner and modulates the high-speed electrical signal in a duo-binary modulation scheme, the method comprising:
dividing frequency of a sinusoidal watchdog clock signal which is output from the signal combiner, added to DC bias voltage, and input to the optical modulator;
determining if high and low peak voltages of a signal, which is optically modulated, electrically converted and output, and is filtered to the same frequency band as that of the divided frequency of the watchdog clock signal, satisfy a reference voltage condition; and
adjusting the DC bias voltage unless the high and low peak voltages satisfy the reference voltage condition.

19. The method of claim 18, wherein if there is an error on the signal input to the optical modulator, adjusting the DC bias voltage is not performed.

20. The method of claim 19, wherein it is determined from information about transmission data locking if there is an error on the signal input to the optical modulator.
